(19) United States
(12) Patent Application Publication
(10) Pub. No.: US 2019/0272970 A1
(43) Pub. Date: Sep. 5, 2019

(54) STATIC COLLIMATOR FOR REDUCING SPOT SIZE OF AN ELECTRON BEAM

(71) Applicant: AcceleRAD Technologies, Inc., Belmont, CA (US)

(72) Inventor: Curtis Allen, Redwood City, CA (US)

(21) Appl. No.: 16/290,338

(22) Filed: Mar. 1, 2019

Related U.S. Application Data
(60) Provisional application No. 62/637,626, filed on Mar. 2, 2018.

(51) Int. Cl. H01J 35/14; H05H 9/04; H01J 35/12

(52) U.S. Cl. CPC H01J 35/14; H01J 35/12; H05H 9/048

(57) ABSTRACT

Electron beam collimators and linear accelerators include a target and a collimator body. The collimator body has a central aperture that opens at an exit to the target and has a final internal diameter at the exit that defines an electron beam spot size on the target.

### RELATED APPLICATION INFORMATION

This application claims priority to U.S. Provisional Patent Application No. 62/637,626, filed on Mar. 2, 2018, incorporated herein by reference herein its entirety.

### BACKGROUND

The present invention generally relates to particle beam systems and, more particularly, to collimators configured to reduce the spot size of electron beams.

Electron beam spot size on a bremsstrahlung converter (also known as a “target” in the context of a linear particle accelerator) affects imaging resolution for industrial and medical imaging applications. Reducing the spot size improves imaging resolution and, in the treatment of cancer, provides an improved penumbra when using high-energy x-rays. One way to reduce spot size is to use external magnetic fields to reduce the beam's diameter. However, this adds cost, complexity, and weight. Other approaches degrade the electron beam's penumbra and current distribution.

### SUMMARY

An electron beam collimator includes a target and a collimator body. The collimator body has a central aperture that opens at an exit to the target and has a final internal diameter at the exit that defines an electron beam spot size on the target.

A linear accelerator includes an electron source that emits an electron beam. A set of resonant cavities are configured to accelerate the beam of electrons. A collimator body has a central aperture that receives the beam of electrons at an entry and that opens at an exit to the target. The aperture has a final internal diameter at the exit that defines an electron beam spot size on the target.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram illustrating a linear accelerator that includes an electron gun, a set of accelerating cavities, and a drift section with a target for an electron beam in accordance with an embodiment of the present invention;

FIG. 2 is a diagram showing detail of an electron gun and its interface with the set of accelerating cavities in accordance with an embodiment of the present invention;

FIG. 3 is a diagram showing detail of a drift section that includes an electron beam collimator that absorbs electrons outside of a specified spot size in accordance with an embodiment of the present invention;

FIG. 4 is a diagram showing detail of the drift section and its interface with the set of accelerating cavities in accordance with an embodiment of the present invention;

FIG. 5 is a set of graphs comparing electron beam current density between a linear accelerator with without a collimator and with a collimator in accordance with an embodiment of the present invention; and

FIG. 6 is a diagram showing detail of a drift section that includes a first, tapered collimator and a second, cylindrical collimator that absorb electrons outside of a specified spot size in accordance with an embodiment of the present invention.

### DETAILED DESCRIPTION

Embodiments of the present invention provide a static collimator for an electron beam, positioned inside the vacuum envelope of a linear particle accelerator, in the drift section, after the last accelerating cell, and before the target. The collimator provides a reduced spot size for the electron beam on the target, providing improved resolution and penumbra characteristics without necessitating a redesign of the accelerator and without high or increased current densities. Embodiments of the present invention can be used as a collimator for electrons in any appropriate device that uses an electron beam.

Toward that end, embodiments of the present invention use a collimator with an inside diameter that is smaller than the electron beam, selectively removing the outer electrons from the beam. This produces a beam with a circular cross-section and with a well-defined outer edge. The collimator is aligned along the axis of the linear particle accelerator to produce a point of impact on the target that can be made concentric with the target. By collimating the electron beam just before the beam reaches the target, the present embodiments provide a well-controlled diameter across a wide variety of different electron beam structures. The present embodiments can thus be implemented with a mechanical device that can be adapted to existing linear particle accelerator designs.

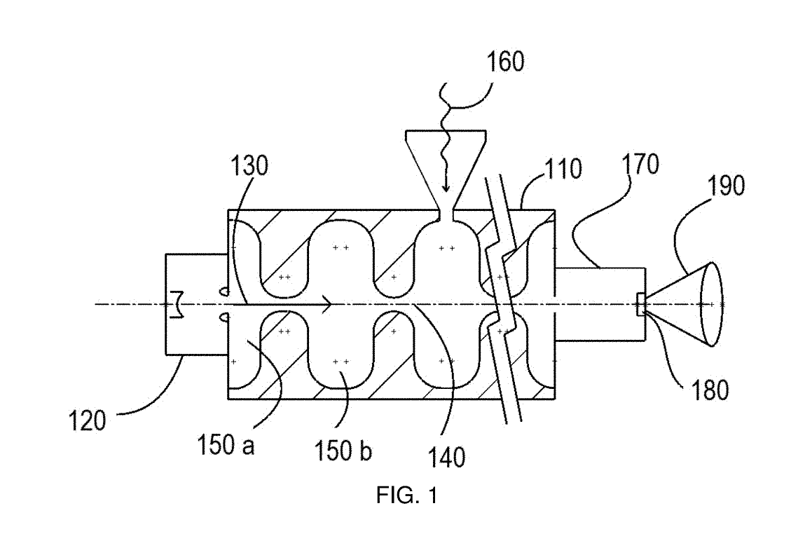

Referring now to the drawings in which like numerals represent the same or similar elements and initially to FIG. 1, a cross-sectional view of an exemplary linear particle accelerator (LINAC) 110 is shown. An electron gun 120 emits an electron beam 130 along an axis 140, which is the common axis for both the electron linear accelerator 110 as well as the electron gun 120. The electron beam 130 is accelerated through cavities a set of cavities 150 (labeled as 150a, 150b, etc.). The cavities 150 are powered by microwave power 160, which can also be referred to as radio frequency (RF) power and electromagnetic power. Electrons leave the accelerator cavities 150 and enter into a drift section 170 before impacting the target 180. The exemplary electron linear accelerator 110 thus produces a high-energy x-rays (photons) 190 as its output.

When the electrons in the beam 130 impact the target 180, they are rapidly decelerated, producing bremsstrahlung radiation (x-rays). The target 180 can be formed from a material with a high atomic number, for better X-ray conversion efficiency, such as tungsten or a tungsten alloy, rhenium, or copper, with high thermal conductivity and a high melting temperature. The present embodiments can be used with both transmission-type and reflection-type targets. The target 180 is made from a durable material that can withstand a high number of electrons (also known as a high beam current), thereby providing a high x-ray flux rate or dose rate.

When used for imaging, a small electron beam spot size produces a small x-ray spot size, making it possible to resolve smaller structures. In some applications, a spot size of 2.0 mm is suitable to provide acceptable imaging radiation with a dose rate that won't damage the target from too high a power density.

However, the current density of electron beams leaving the cavities 150 generally does not have a classic Gaussian current distribution, resulting in a spot size without a well-defined outer edge. The current distribution tends to have a concentration high current density near the middle and lower current density at the outer diameter, known as a conical distribution, and sometimes described as a double Gaussian, increasing the risk of damage to the target 180. In imaging application, such a conical distribution provides a much less defined outer edge, producing a degraded resolution and a degraded penumbra relative to an optimal penumbra, where there would be a single point of impact on the target.

While a LINAC 110 is particularly contemplated, it should be understood that the present embodiments can be used with any appropriate form of vacuum electron device, such as an x-ray tube, which uses a target to covert electrons to x-rays from the loss of electron energy inside the target material. The LINAC 110 can be any appropriate linear accelerator (e.g., standing wave and traveling wave LINACs) and can be used toward such ends as medical, industrial, and security applications. A standing wave LINAC can be of the bi-periodic, axially coupled type, the magnetically side-coupled time, or the bi-periodic, magnetically coupled time. LINACs based on a constant impedance approach or those based on a constant gradient approach can similarly be used.

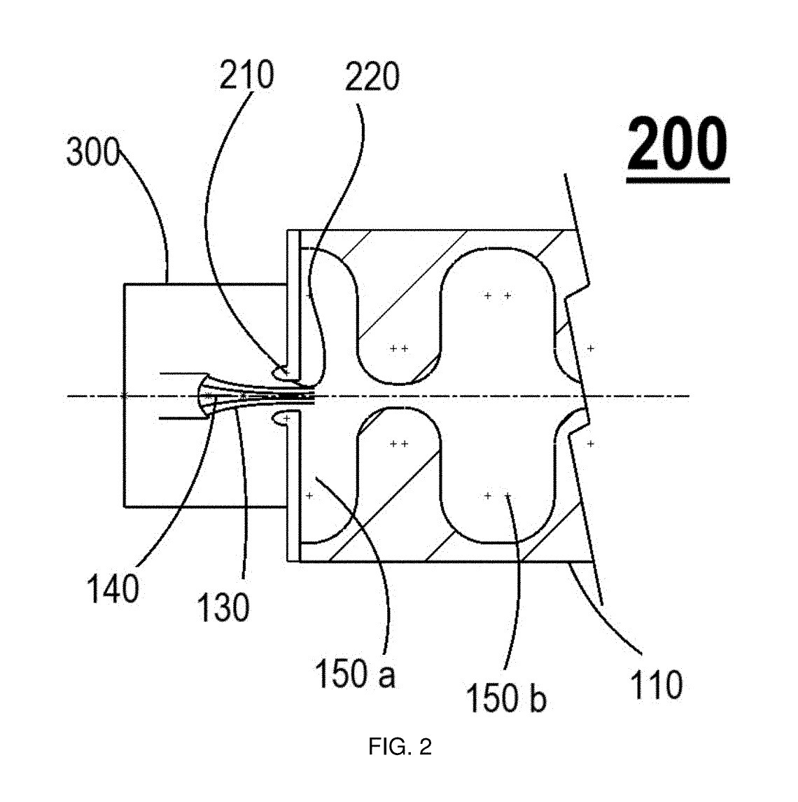

Referring now to FIG. 2, a cross-sectional view 200 of an electron gun 300 is shown, providing greater detail on the interface between the electron gun 300 and the LINAC 110. The electron gun 300 emits electron beam 130 along the axis 140 towards an anode 210 which is connected mechanically and electrically to the exemplary LINAC 110. The electron beam 130 passes through a center aperture 220 in the anode 210 onto the LINAC 110. Only the first two cavities 150a, and 150b of the electron linear accelerator are shown. The center of anode aperture 220 is aligned with the axis 140 which is the common axis for both the electron gun 300 and the LINAC 110.

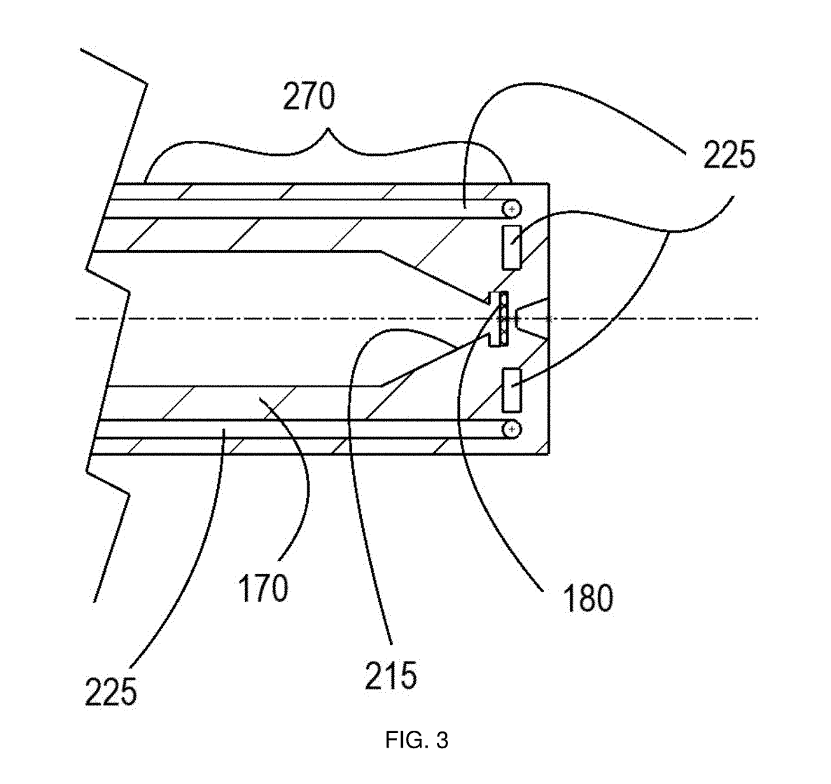

Referring now to FIG. 3, additional detail on the drift section 170 is shown. Collimator 215 and target 180 are shown, being positioned after the accelerating cavities of the LINAC 110. The target 180 and collimator 215 are cooled by a thermal conduction path to cooling channels 225, which may use a flow of cooling water to remove heat.

The drift section 170 can be any appropriate length, as measured along the shared axis 140, and its function can be combined with that of the collimator 215. The structure of the collimator 215 can include a reduction in diameter that is abrupt or gradual, with tapered profiles having the benefit of spreading electron interception over a larger surface area, thereby keeping the surface cooler. In some embodiments, the tapered profile of the internal diameter can extend the entire length of the collimator. In other embodiments, the collimator may have one or more sections of constant internal diameter in addition to a tapered section. The cooling channels 225 can run through the collimator 215 and can additionally bring water to, or near, the target 180 to help cool the target 180 as well.

Behind the target 180 is a heat sink section that includes the cooling channels 225. This section, which may for example be formed from copper or any other appropriate material with a low atomic number and high thermal conductivity, conducts heat away from the target 180. For those electrons in the electron beam that pass through the target 180 without colliding, relatively few will impact the material of the heat sink section to create x-rays there.

The target 180 can be mounted within the drift section 170 by any appropriate mechanism, such as brazing, via a high-vacuum flange, or via a weld flange. The target 180 can be integrated with the collimator 215 or can, alternatively, be a separately attachable device that connects to an output of the collimator 215. It is specifically contemplated that the heat sink may therefore be formed as a continuous structure with the collimator 215, as shown, or may be a separate structure. The target 180 may, in some embodiments, be brazed to the heat sink section.

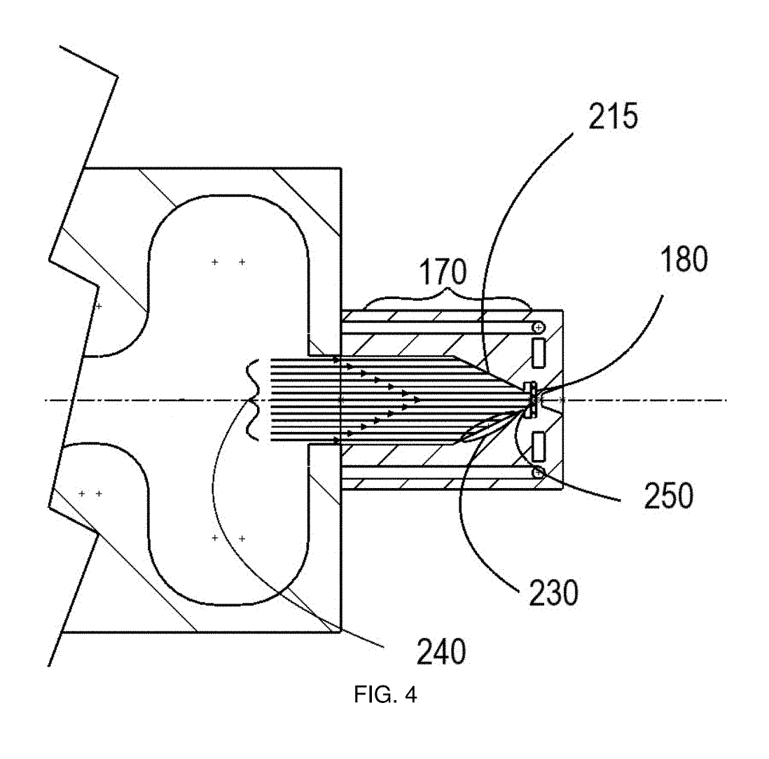

Referring now to FIG. 4, additional detail is shown regarding the blocking of part of electron beam 240, which is the part of electron beam 130 that is within the drift section 170. As the electron beam 240 passes through the collimator 215, electrons in the outer diameter of the electron beam 240 impact the sidewalls of the collimator 215 and are blocked or absorbed. The portion of the electron beam 240 that passes through the collimator 215 reaches the target 180 with a reduced spot size 250 without the increased current density that would result from focusing the beam using, for example, magnetic fields.

It is specifically contemplated that the drift section 170 can be attached to the LINAC 110 by brazing or any other appropriate process, such as welding or bolting. In other embodiments, the drift section 170 may be kept separate from the LINAC 110, while in still other embodiments the drift section 170 may be formed as a continuous part of the LINAC 110. Collimator 215, in turn, can be a separate structure that is attached to the drift section 170 by, e.g., brazing or any other appropriate process. In other embodiments, collimator 215 can be formed as a continuous part of the drift section 170.

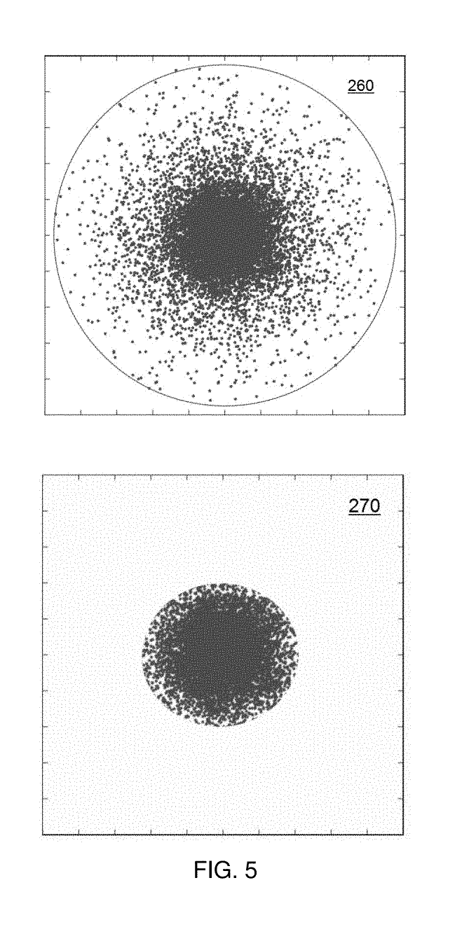

Referring now to FIG. 5, graphs are shown that depict an original current density 260 of the electron beam 240 without collimation and a final current density 270 of the electron beam 240 after collimation. The x-axis and y-axis of each graph represent a spatial cross-section of the electron beam 240, with a greater density of points representing a higher current density and with a lower density of points representing a lower current density. Whereas the non-collimated current density 260 shows a low current density that extends to a substantial radius away from the electron beam's center, the collimated current density 270 shows a sharp cut-off at a well-defined boundary, without substantially increasing the current density within the boundary. One benefit of reducing the beam diameter is that the outside diameter of the target can also be reduced, making the radial path from the point of impact to the heat sink shorter, thereby improving and/or lowering the target's operating temperature.

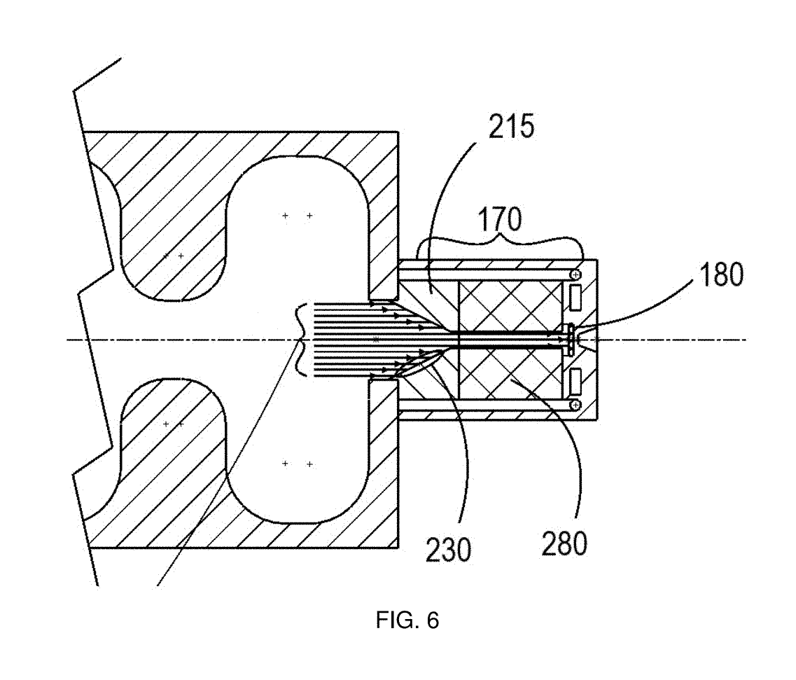

Referring now to FIG. 6, a cross-sectional view of the collimator is shown that provides additional detail for some embodiments. In these embodiments, the collimator can be formed from two sections, including a first, tapered collimator portion 215 and a second, cylindrical collimator portion 280. The first collimator portion 215 can be formed from, e.g., oxygen-free electronic copper or other material that has a low vapor pressure, good conductivity, and high melting temperature. Other appropriate materials include molybdenum and tungsten. The second collimator portion 280 can be formed from a material with a high atomic number, such as tungsten. X-rays that are produced by blocked/absorbed electrons 230 striking the material of the first collimator portion 215 are attenuated by the high atomic number material of the second collimator portion, preventing those x-rays from interfering with the application at hand. In other embodiments, the inner surface of the collimator 215/280 can be lined with tungsten to help shield and/or attenuate the x-ray flux and unwanted background radiation in both the axial and radial directions.

The internal diameter of the collimator 215 is selected to produce a particular spot size on the target 180. The internal diameter may taper from a wide initial diameter to a narrower final diameter to spread out the captured electrons. It is contemplated that the final internal diameter of the collimator may be smaller than about 2 mm, with a range between 0.5 mm and 1.5 mm being specifically contemplated. The outer diameter of the collimator 215 is selected to fit into the drift section 170 or, if the collimator 215 is built into the exit of the last accelerating cell of the LINAC 110, then to be fit appropriately to that structure. The overall diameter of the drift section 170 is kept small, to minimize the size and weight of lead shielding that is placed around the drift section. The shielding is used to prevent misdirected x-rays (back-ground radiation) from escaping. Although the outer diameter of the collimator 215 can be any appropriate size, it is specifically contemplated that the outer diameter may be in a range between 1″ and 1.5″.

It should understood that when an element, such as a component, device, or other structure, is referred to as being “on” or “over” another element, it can be directly on the other element or intervening elements can also be present. In contrast, when an element is referred to as being “directly on” or “directly over” another element, there are no intervening elements present. It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps operations, elements, components and/or groups thereof.

Spatially relative terms, such as “beneath,” “below,” “lower,” “above,” “upper,” and the like, can be used herein for ease of description to describe one element's or feature's relationship to another element(s) or feature(s) as illustrated in the FIGS. It will be understood that the spatially relative terms are intended to encompass different orientations of the device in use or operation in addition to the orientation depicted in the FIGS. For example, if the device in the FIGS. is turned over, elements described as “below” or “beneath” other elements or features would then be oriented “above” the other elements or features. Thus, the term “below” can encompass both an orientation of above and below. The device can be otherwise oriented (rotated 90 degrees or at other orientations), and the spatially relative descriptors used herein can be interpreted accordingly. In addition, it will also be understood that when a layer is referred to as being “between” two layers, it can be the only layer between the two layers, or one or more intervening layers can also be present.

It will be understood that, although the terms first, second, etc. can be used herein to describe various elements, these elements should not be limited by these terms. These terms are only used to distinguish one element from another element. Thus, a first element discussed below could be termed a second element without departing from the scope of the present concept.

Having described preferred embodiments of a static collimator for reducing spot size of an electron beam (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. An electron beam collimator, comprising:
a target;
a collimator body having a central aperture that opens at an exit to the target and that has a final internal diameter at the exit that defines an electron beam spot size on the target.

2. The electron beam collimator of claim 1, wherein the central aperture has an initial internal diameter at an entry that is larger than the internal diameter at the exit end.

3. The electron beam collimator of claim 2, wherein the aperture has a tapered section that transitions from the initial internal diameter to the final internal diameter.

4. The electron beam collimator of claim 1, wherein the target is brazed to the collimator body.

5. The electron beam collimator of claim 1, further comprising one or more cooling channels in contact with the collimator body.

6. The electron beam collimator of claim 1, further comprising a heat sink section that is thermally coupled to collimator body and that is positioned on a far side of the target from the collimator body.

7. The electron beam collimator of claim 1, further comprising a cylindrical section positioned between the collimator body and the target.

8. The electron beam collimator of claim 1, wherein an internal surface of the aperture is lined with tungsten.

9. The electron beam collimator of claim 1, wherein the collimator body is formed from a material selected from the group consisting of oxygen-free copper, molybdenum, and tungsten.

10. A linear accelerator, comprising:
an electron source that emits an electron beam;
a plurality of resonant cavities configured to accelerate the beam of electrons;
a target; and
a collimator body having a central aperture that receives the beam of electrons at an entry, that opens at an exit to the target, and that has a final internal diameter at the exit that defines an electron beam spot size on the target.

11. The linear accelerator of claim 10, wherein the central aperture has an initial internal diameter at the entry that is larger than the internal diameter at the exit.

12. The linear accelerator of claim 11, wherein the aperture has a tapered section that transitions from the initial internal diameter to the final internal diameter.

13. The linear accelerator of claim 10, wherein the target is brazed to a heat sink and wherein the heat sink is brazed to the collimator body.

14. The linear accelerator of claim 10, further comprising one or more cooling channels in contact with the collimator body.

15. The linear accelerator of claim 10, further comprising a heat sink section that is thermally coupled to target and the collimator body and that is positioned on a far side of the target from the collimator body.

16. The linear accelerator of claim 10, further comprising a cylindrical section positioned between the collimator body and the target.

17. The linear accelerator beam collimator of claim 10, wherein an internal surface of the aperture is lined with tungsten.

18. The linear accelerator of claim 10, wherein the collimator body is formed from a material selected from the group consisting of oxygen-free copper, molybdenum, and tungsten.

19. The linear accelerator of claim 10, further comprising a drift section that is attached to a final resonant cavity of the plurality of resonant cavities and that houses the collimator and the target.
